(19) United States
(12) Patent Application Publication
(10) Pub. No.: US 2014/0204216 A1
(43) Pub. Date: Jul. 24, 2014

(54) Radioactivity detection method

(71) Applicant: Francois ANTIER, La Combe De Lancey (FR)

(72) Inventor: Francois ANTIER, La Combe De Lancey (FR)

(21) Appl. No.: 13/543,838

(22) Filed: Jul. 8, 2012

Related U.S. Application Data
(60) Provisional application No. 61/507,620, filed on Jul. 14, 2011.

(51) Int. Cl. G01T 1/167; H04N 5/30

(52) U.S. Cl. CPC G01T 1/167; H04N 5/30
USPC 348/162

(57) ABSTRACT

A method for measuring radioactivity using standard cameras in customer appliances.

### CROSS-REFERENCE TO RELATED APPLICATION

This application claims the benefit of U.S. Provisional Application No. 61,507,620, filed Jul. 14, 2011.

### FIELD OF THE INVENTION

The present invention is in the field of physical measurement. More particularly, the present invention is in the technical field of radioactivity detection.

### BACKGROUND OF THE INVENTION

Radioactive materials are widely used in scientific installations and electricity-producing facilities. People may want to measure the level of ambient radioactivity around them, especially after accidents in nuclear plants. Sophisticated customer appliances such as mobile phones and tablets are in widespread use today. Using these existing devices to measure ambient radiation would provide a solution that would be 1) very inexpensive 2) easy to scale up in case of emergency, since no physical production would be needed.

### SUMMARY OF THE INVENTION

The invention consists of using standard cameras located in consumer devices as radioactivity detectors.

This essentially adds a radiation-measuring capability to tens of millions of devices located worldwide, without the price or weight of an additional, dedicated radiation sensor.

Tests conducted show that devices used with this invention can be used to measure typical radiation (such as gamma rays emitted by a Cs137 source), over a wide span of radiation levels, starting as low as the level of natural radiation.

### DETAILED DESCRIPTION OF THE INVENTION

The camera must be masked so that no light or very little light reaches the camera sensor.

Radioactive rays which are not stopped by this mask, and which reach the camera sensor, can change the value associated with the pixel or pixels hit by the radiation.

One simple algorithm for detecting such events is to analyze the video stream that is output by the camera sensor or processor, and to count how many pixels have a value higher than the value of pixels not hit by the radioactive ray. More sophisticated image analysis can also be used.

This process can be continued over several images, to improve the device sensitivity.

A radioactivity value may then be computed, using a formula such as

R=event_count/(measurement_period*sensor_yield)

where R is the value of the measured radioactivity level,
event_count is the number of events over the measurement period,
sensor_yield is the sensor efficiency, whose value is determined by experiment,
and measurement_period is the length of time over which events are counted.

1. What is claimed consists of the method of measuring radioactivity using consumer device camera sensors that have been masked.
